(19) United States
(12) Patent Application Publication
(10) Pub. No.: US 2005/0269732 A1
(43) Pub. Date: Dec. 8, 2005

(54) Support plate for semiconductor components

(75) Inventors: Franciscus Cupertinus Maria De Haas, Eindhoven (NL); Johannes Maria Emanuel Van Laarhoven, Einhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/527,432

(22) PCT Filed: Aug. 18, 2003
(86) PCT No.: PCT/IB03/03675

§ 371 Date: Mar. 9, 2005

(30) Foreign Application Priority Data
Sep. 12, 2002 (EP) 02078763.6

(51) Int. Cl. B44C 1/22

(52) U.S. Cl. 264/162; 118/728; 156/345.51; 216/52

(57) ABSTRACT

The present invention relates to a support plate (1), preferably made from glass, granite or ceramic, for supporting components (3), in particular ICs or other semiconductor components. The top face of the support plate (1) is at least partially roughened (roughened areas (2)), resulting in a roughness Ra of preferably about 0.3 micrometer. Further, the present invention relates to a packaging unit (4) comprising the support plate (1).

The present invention relates in a first aspect to a support plate for supporting at least one component, in particular a wafer, on the top face of said support plate. In a further aspect, the present invention relates to a method for the preparation of said support plate. In an even further aspect, the present invention relates to a packaging unit comprising said support plate. In a still further aspect, the present invention relates to the use of said support plate, the use of said packaging unit and the use of a non-corrosive, non-contaminating material.

In the IC packaging and semiconductor industry, components are usually packaged in and/or supported by plastic materials. A problem that often occurs when using plastics for packaging and/or supporting components is that the plastics contain plasticizers and, optionally, other auxiliary ingredients that may diffuse from the plastics onto the components resulting in contamination of the components. In some cases this diffusion of plasticizers or other auxiliary ingredients even causes the components to be adhered to the plastic materials.

The above problem is particularly pertinent in the case of IC and semiconductor components, as it very important to avoid contamination of these components. As a result, the components often have to be cleaned again after storage on or in the plastic materials, even if an appropriate protection against the environment is secured. It goes without saying that this is highly undesirable.

A further problem that often occurs when using small IC and semiconductor components, in particular when the components have a thin sheet-like design, such as in the case of wafers, is that, when such components are applied on a substantially smooth and flat support (such as e.g. a slide for spectroscopic analysis), the formation of an ‘air cushion’ between the support and the component to be supported is likely to occur. As a result the component will tend to float on, and in some cases away from, the support. Therefore, it is difficult to obtain a precise and unambiguous positioning of the component on the support.

However, if eventually a suitable positioning of the component on the support has been achieved the components may tend to stick (e.g. under influence of the Van der Waals forces) to the support. It goes without saying that this sticking is highly undesired as it results in an ineffective way of working and therefore in a considerable loss of time.

In the prior art it has been proposed to provide sucking holes in supports to enable IC and other semiconductor components to be sucked to the support. In this respect reference is made to the following two patent applications.

EP-A-1,091,400 describes a wafer probe comprising a ceramic substrate and a conductor layer formed on the surface thereof. On the surface of the ceramic substrate of the wafer probe channels may be formed, the channels being provided with air suction holes.

The abstract of Japanese application 60-095148 (publication no.: 61-252642) describes a chip supporting table for testing semiconductor IC chips. The chips are firmly held on the work table as they are sucked with a vacuum through sucking holes.

It is an object of the present invention to avoid one or more of the above-mentioned or other problems.

It is a further object of the present invention to avoid the need of suction holes and associated vacuum suction equipment which must be installed, maintained, repaired, energized, etc.

It is a still further object of the present invention to provide a support plate for supporting at least one component, in particular an IC or other semiconductor component, more particular a wafer, on which support plate the component may be positioned precisely and unambiguously.

It is a further object to provide a method for the preparation of a support plate according to the invention.

It is an even further object to provide a packaging unit comprising said support plate.

Furthermore, it is an object of the present invention to provide for the use of said support plate, the use of said packaging unit and the use of a non-corrosive, non-contaminating material for supporting and storing components, in particular IC and other semiconductor components, more particular wafers.

One or more of the above objects are achieved by a support plate according to the present invention for supporting at least one component, in particular an IC or other semiconductor component, more particular a wafer, on a top face of said support plate, characterized in that the top face of the support plate is at least partially roughened.

The support plate according to the present invention provides in a surprisingly simple and cost-effective manner for a contamination-free, precise and unambiguous positioning of the component on the support plate.

Generally, the support plate may be any substantially flat plate, such as a worktop, a slide for spectroscopic analysis, etc.

The whole top face of the support plate may be roughened. Instead, only certain areas may be roughened.

The components to be supported may be any component, preferably the components are ICs or other semiconductor components. Even more preferably, the components are small, substantially flat sheet-like components such as a wafer.

Advantageously, the at least partially roughened top face of the support plate has a roughness Ra in the range of 0.10-3.0 μm, preferably in the range of 0.20-2.0 μm, even more preferably in the range of 0.25-1.0 μm, most preferably about 0.3 μm. It has been shown that these roughnesses allow for a precise and unambiguous positioning of the component on the support plate.

Even more preferably, the top face of the roughened support plate comprises a groove or a pattern of grooves, the at least one groove preferably preventing or at least minimizing the formation of an ‘air cushion’ between the top face and the at least one component. Herewith it is prevented that the component will float on, or even away from, the support.

The person skilled in the art will readily understand how to design the groove or pattern of grooves in order to achieve the desired effect. Generally, any groove or pattern of grooves may be used, as long as the formation of an ‘air cushion’ between the top face of the support plate and the component to be supported by the support plate is prevented or at least minimized.

It has been shown that very effective positioning results may be achieved if the at least one groove has a depth of about 0.20 mm.

According to a preferred embodiment, the top face of the roughened support plate comprises at least one recess for at least partially receiving the component to be supported. Herewith, the positioning of the component is further improved. The person skilled in the art will readily understand that the recess may have any suitable form in order to receive and accommodate the component to be supported. If desired, two or more recesses may be provided to receive more than one component.

Although the support plate may be made from any suitable material, the support plate is made from a non-corrosive, non-contaminating material. Herewith it is prevented that the component is contaminated, such as is the case when using plastics for packaging or supporting components.

According to the present invention by “a non-corrosive, non-contaminating material” is meant any material that does not cause deterioration of the component to be supported or packaged.

More preferably, the support plate is made from a material selected from a group of materials comprising glass, granite and ceramic (including technical ceramic) and a combination thereof, more preferably the material is glass, most preferably transparent glass. All types of glass (e.g. soda lime glass, borosilicate glass [Pyrex®], etc.), granite and ceramic may be used.

In a further aspect the present invention relates to the use of the support plate according to present invention as a slide for spectroscopic analysis. As the top face of the slide is roughened as outlined above, the component may be easily and precisely positioned on the top face, without the tendency to float away from the slide. After the component on the slide has been submitted to the spectroscopic analysis, such as X ray analysis, the component may be easily removed from the slide, if desired using a pair of tweezers or the like, without the tendency to stick to the slide. Usually the slide will be made from a transparent material such as glass.

In this respect it is preferred that the top face of the slide has a roughness such that, during spectroscopic analysis, no interference caused by the roughness of the top face of the slide occurs. The person skilled in the art will readily understand how to choose the roughness of the top face of the slide to prevent such interference.

In an even further aspect, the present invention relates to a method for the preparation of a support plate for supporting at least one component, in particular an IC or other semiconductor component, more particularly a wafer, on a top face of said support plate, characterized by the steps of:
forming the support plate; and
roughening the top face of the formed support plate at least partially using powder blasting, such that the at least partially roughened top face of the support plate has a roughness Ra in the range of 0.10-3.0 μm, preferably in the range of 0.20-2.0 μm, even more preferably in the range of 0.25-1.0 μm, most preferably about 0.3 μm.

It has been surprisingly shown that the use of powder blasting to roughen the top face of the support results in high-accuracy mechanical etching of the supports according to the present invention. Furthermore, powder blasting has shown to be a very versatile technique. If desired, masks may be used to obtain a particular pattern of roughened and non-roughened areas on the top face of the support plate.

As the method of powder blasting is known as such it is not necessary to illustrate the method in further detail. In this respect reference is made to e.g. Slikkerveer, P. J. et al., “High quality mechanical etching of brittle material by powder blasting”, Eurosensors XIII, The 13th European Conference on solid-state transducers, Sep. 12-15, 1999, The Hague, The Netherlands, pp. 655-662.

In an even further aspect, the present invention relates to a packaging unit for packaging at least one component, in particular an IC component or other semiconductor component, more particularly a wafer, said the packaging unit comprising a support plate according to the invention.

The person skilled in the art will readily understand that the packaging unit may have any suitable form, shape or design. For example, the packaging unit may be a Petri dish, wherein the lower dish is the support plate and the upper dish seals the at least partially roughened lower dish.

According to a preferred alternative embodiment, the packaging unit further comprises a cover plate having a bottom face facing the top face of the support plate, the bottom face of the cover plate being at least partially roughened and being releasably connectable to the top face of the support plate.

According to a further alternative embodiment, the top face of the support plate and the bottom face of the cover plate each comprise at least one recess, which recesses are designed to at least partially receive a component to be packaged.

Furthermore, the present invention relates to the use of the packaging unit for storage of components, in particular IC ore other semiconductor components, more particularly wafers.

Finally, the present invention relates to the use of a non-corrosive, non-contaminating material, preferably selected from the group comprising glass, granite and ceramic and a combination thereof, more preferably glass, most preferably transparent glass in the packaging of ICs or other semiconductor components, in particular wafers. It has been shown that the use of the above-mentioned materials, in particular glass, avoids the problem of contamination of the components to be stored.

These and other aspects of the present invention will be apparent from and elucidated with reference to the embodiment(s) described hereinafter.

Hereinafter the present invention will be illustrated in more detail by a drawing. Herein shows:

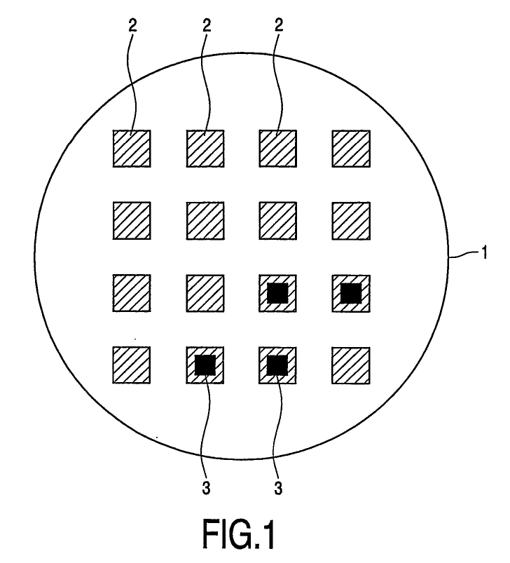

FIG. 1 a schematic top view of the support plate according to the present invention;

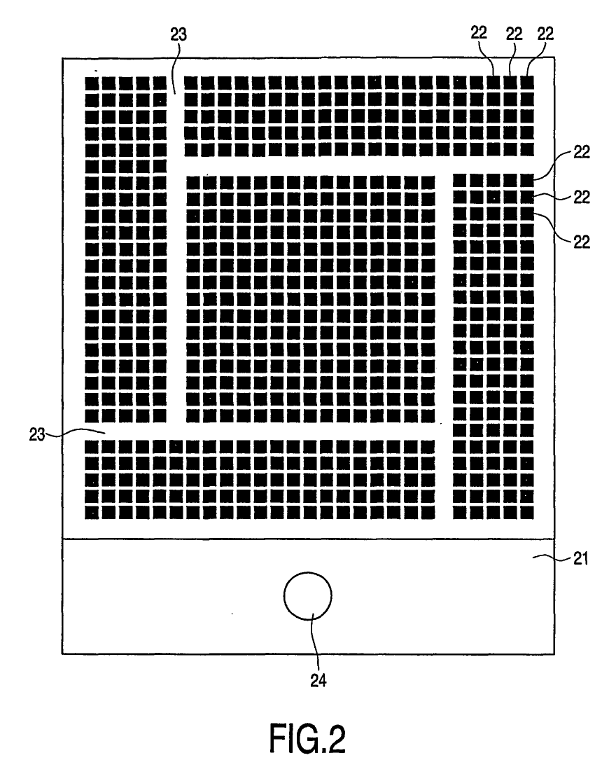

FIG. 2 an enlarged schematic top view of the support plate according to the present invention in the form of a slide;

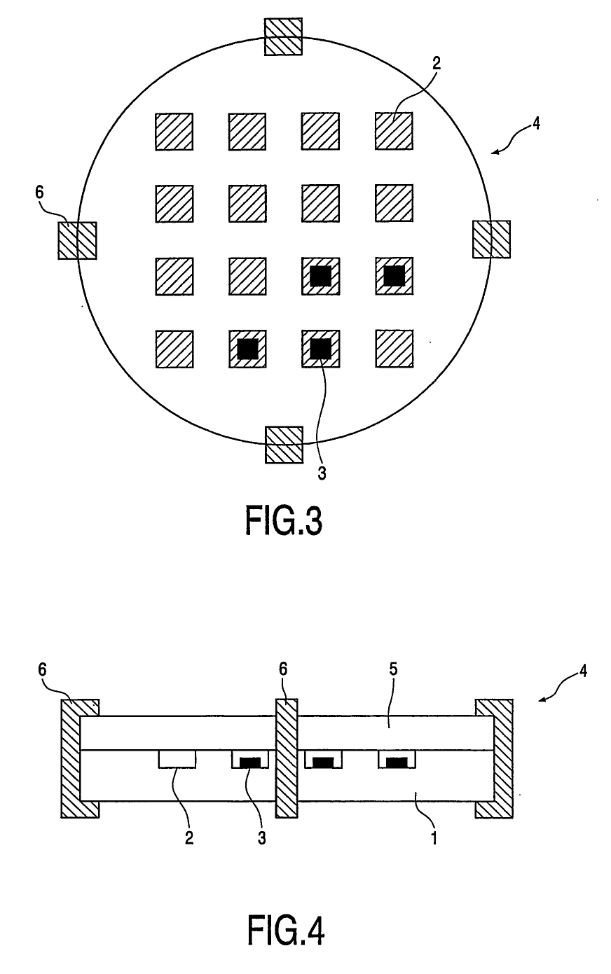

FIG. 3 a schematic top view of a first embodiment of the packaging unit according to the present invention comprising the support plate according to FIG. 1;

FIG. 4 a schematic cross-sectional view of the packaging unit according to FIG. 3; and

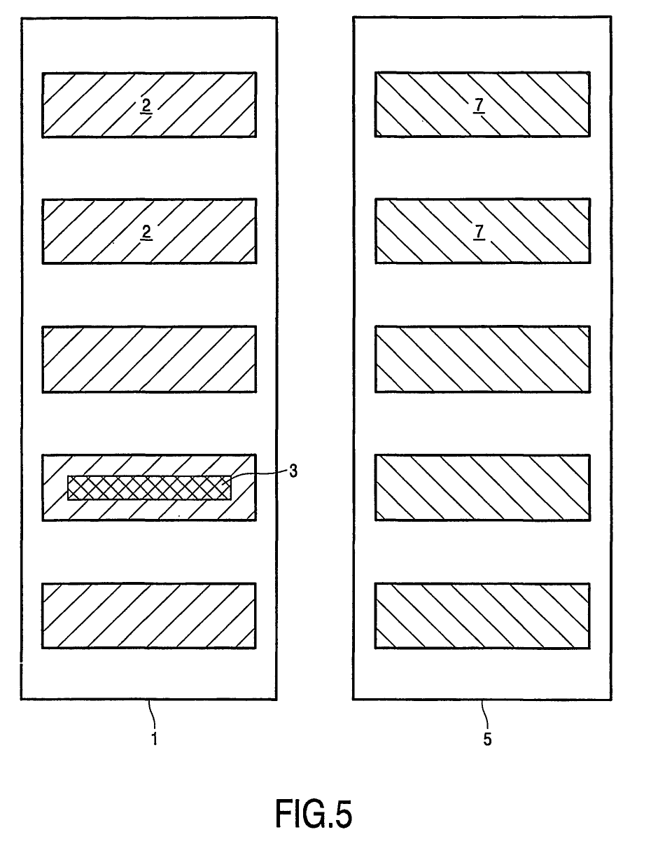

FIG. 5 a schematic top view of a second embodiment of the packaging unit according to the present invention.

Identical reference numbers indicate similar structural components.

FIG. 1 shows a schematic top view of a disk shaped support plate 1 made from glass. On the top face of the support plate 1 a pattern of roughened areas 2 is formed. The areas 2 have a roughness Ra of about 0.3 μm. Furthermore the areas 2 are recessed with respect to the top face of the support plate 1, the recesses having a depth of 0.5 mm. On the roughened surface of some of the areas 2, components 3 are placed.

The roughened areas 2 have been obtained by powder blasting the top face of the support plate 1 using a mask.

FIG. 2 shows an enlarged schematic top view of a slide 21 made from transparent glass. The top face of the slide 21 comprises a plurality of studs 22 projecting from the top face of the slide 21. The top side of the studs 22 has been roughened to obtain a roughness Ra of about 0.3 μm.

On the top face of the slide 21 a pattern of grooves 23 is present separating the studs 22. The grooves 23 serve to prevent, or at least minimize, the formation of an ‘air cushion’ between the top face of the studs 22 of the slide 21 and the one component (not shown) to be placed on the slide 21. Furthermore, the slide 21 comprises a through hole 24, which hole 24 can be penetrated by a pin of a spectroscopic analyzer (not shown) to firmly attach the slide 21.

The component can be easily positioned on the slide 21 without the risk of floating away from the slide 21. Also, the component can afterwards be removed from the slide 21, without the tendency to adhere to the slide 21.

FIG. 3 shows a schematic top view of a first embodiment of a packaging unit 4. The packaging unit 4 comprises the support plate 1 as shown in FIG. 1, the components 3 placed on the roughened areas 2, a further transparent disk 5 (cf. FIG. 4) and connectors 6, such as clamps or clips, in order to releasably connect the support plate 1 to the further disk 5.

As can be clearly seen from FIG. 4, the disk 5 is placed on the support plate 1.

Finally, FIG. 5 shows a schematic top view of a second embodiment of the packaging unit 4, in which the support plate 1 and the cover plate 5 are arranged next to each other for illustrative purposes. In this case, the support plate 1 and the cover plate 5 are rectangular in shape.

In the embodiment of FIG. 5 the cover plate 5 is provided with roughened projecting areas 7 (Ra˜0.3) which are complementary to the recessed areas 2. Instead the projections 7 may be recessed, such that the recesses 2 and 7 form a cavity to at least partially receive a component 3 to be packaged.

The person skilled in the art will understand that many modifications may be made without departing from the scope of the appended claims. For instance, the packaging unit may be in the form of a Petri dish, comprising a lower and upper disk, wherein the lower disk may contain, on the top face thereof, roughened areas. Further, the lower disk of the Petri dish may be used as a slide.

1. Support plate for supporting at least one component, in particular an IC or other semiconductor component, more particularly a wafer, on a top face of said support plate, characterized in that the top face is at least partially roughened.

2. Support plate according to claim 1, wherein the at least partially roughened top face of the support plate has a roughness Ra in the range of 0.10-3.0 μm, preferably in the range of 0.20-2.0 μm, even more preferably in the range of 0.25-1.0 μm, most preferably about 0.3 μm.

3. Support plate according to claim 1, wherein the top face comprises a groove or a pattern of grooves, the at least one groove preferably preventing or at least minimizing the formation of an ‘air cushion’ between the top face and the at least one component.

4. Support plate according to claim 3, wherein the at least one groove has a depth of about 0.20 mm.

5. Support plate according to claim 1, wherein the top face comprises at least one recess for at least partially receiving the at least one component.

6. Support plate according to claim 1, wherein the support plate is made from a non-corrosive, non-contaminating material.

7. Support plate according to claim 1, wherein the support plate is made from a material selected from a group of materials comprising glass, granite and ceramic and a combination thereof, more preferably glass, most preferably transparent glass.

8. Use of the support plate according to claim 1 as a slide for spectroscopic analysis.

9. Use according to claim 8, wherein the top face of the slide has a roughness such that, during spectroscopic analysis, no interference caused by the roughness of the top face of the slide occurs.

10. Method for the preparation of a support plate for supporting at least one component, in particular an IC or other semiconductor component, more particularly a wafer, on a top face of said support plate, characterized by the steps of:
forming the support plate; and
roughening the top face of the formed support plate at least partially using powder blasting such that the at least partially roughened top surface of the support plate has a roughness Ra in the range of 0.10-3.0 μm, preferably in the range of 0.20-2.0 μm, even more preferably in the range of 0.25-1.0 μm, most preferably about 0.3 μm.

11. Packaging unit for packaging at least one component, in particular an IC or other semiconductor component, more particularly a wafer, said packaging unit comprising a support plate according to claim 1.

12. Packaging unit according to claim 11, wherein the packaging unit further comprises a cover plate having a bottom face facing the top face of the support plate, the bottom face of the cover plate being at least partially roughened and being releasably connectable to the top face of the support plate.

13. Packaging unit according to claim 10, wherein the top face of the support plate and the bottom face of the cover plate each comprise at least one recess, which recesses are designed to at least partially receive the at least one component to be packaged.

14. Use of the packaging unit according to claim 11 for storage of components, in particular ICs or other semiconductor components, more particularly wafers.

15. Use of a non-corrosive, non-contaminating material, preferably selected from the group comprising glass, granite and ceramic and a combination thereof, more preferably glass, most preferably transparent glass, in the packaging of ICs or other semiconductor components, in particular wafers.
